(19) United States
(12) Patent Application Publication
(10) Pub. No.: US 2023/0367842 A1
(43) Pub. Date: Nov. 16, 2023

(54) SYSTEMS AND METHODS FOR TIME-SERIES FORECASTING

(71) Applicant: Royal Bank of Canada, Toronto (CA)

(72) Inventors: Siqi Liu, Toronto (CA); Andreas Lehrmann, Toronto (CA)

(21) Appl. No.: 18/197,348

(22) Filed: May 15, 2023

Related U.S. Application Data
(60) Provisional application No. 63/342,262, filed on May 16, 2022.

(51) Int. Cl. G06F 17/11

(52) U.S. Cl. CPC G06F 17/11

(57) ABSTRACT

A process for time-series forecasting is described that decouples stationary conditional distribution modeling from non-stationary dynamic modeling. The forecasting can be applied to non-stationary time-series.

### RELATED APPLICATION

The current application claims priority to U.S. Provisional application 63/342,262 filed May 16, 2022, entitled Systems and Methods for Time-Series Forecasting, the entire contents of which is incorporated herein by reference in its entirety.

### TECHNICAL FIELD

The current disclosure relates to time-series forecasting, and in particular to time-series forecasting using non-stationary time series.

### BACKGROUND

Time series forecasting is a cornerstone of modern machine learning and has applications in a broad range of domains, including operational processes, energy, finance and transportation. In recent years, architectures based on deep neural networks have shown impressive results and demonstrated the effectiveness of deep feature and latent state representations.

Despite this progress, current time series forecasting methods often make the implicit assumption that train and test data follow the same data generation process. In real-world applications this assumption is often violated, which is known as non-stationarity and poses serious practical challenges to a model's robustness and predictive power.

An additional, alternative and/or improved process for time-series forecasting of non-stationary time-series is desirable.

### SUMMARY

In accordance with the present disclosure, there is provided a method for time series forecasting comprising: receiving a time-series of observational data (yₜ) for a time (t) from t=1 to T; receiving a time-series of auxiliary data (xₜ) from t=1 to T+H, where: yₜ|y_{<t},x_{≤t}; and H is a number of forecasting steps; aggregating time-invariant local context of the received time-series by applying the received time series to a neural network (g); determining dynamic control variable (ϕₜ) based on time-variant global dynamics of the received time series using a random walk process; predicting parameters of a conditional distribution by modulating the aggregated time-invariant local context by the dynamic control variable; and using the predicted parameters of the of the conditional distribution to forecast observational data yₜ for t=1 to T+H; and outputting yₜ for t=1 to T+H.

In a further embodiment of the method, the neural network g maps yₜ and xₜ to a vector hₜ as: hₜ=g(y_{1:T}, x_{1:T+1}).

In a further embodiment of the method, aggregating the time-invariant context further comprises transforming hₜ into P vectors, each of dimension E.

In a further embodiment of the method, hₜ is transformed into the P vectors according to: z_{t,i}=tan h(W_{z,i}hₜ+b_{z,i}), ∀i=1, . . . , P.

In a further embodiment of the method, rein the dynamic control variable φₜ is determined based on a dynamic stochastic process (χₜ).

In a further embodiment of the method, φₜ is determined according to: φₜ=χₜ+b_{ϕ}, where b_{ϕ} is a static vector.

In a further embodiment of the method, χₜ is determined from a generative process according to: πₜ˜ [symbol] (λ); χₜ˜ [symbol] (0,Σ₀), if πₜ=0; χₜ=χₜ₋₁+∈ₜ if πₜ=1; ∈ₜ˜ [symbol] (0,Σ_{d}), where: [symbol] denotes a Bernoulli distribution; and [symbol] denotes a normal distribution.

In a further embodiment of the method, using the predicted parameters of the of the conditional distribution to forecast observational data yₜ comprises: sampling trajectories of p(χ_{T+1:T+H}|y_{1:T}, x_{1:T}); and sampling trajectories of p(y_{T+1:T+H}|y_{T+1-B:T}, x_{T1-B:T+H}, x_{T+1:T+H}) using the sampled trajectories of p(χ_{T+1:T+H}|y_{1:T}, x_{1:T}).

In a further embodiment of the method, the trajectories of p(χ_{T+1:T+H}|y_{1:T}, x_{1:T}) are sampled from a dynamic model comprising a posterior model and prior model.

In a further embodiment of the method, the trajectories of p(y_{T+1:T+H}|y_{T+1-B:T}, x_{T+1-B:T+H}, χ_{T+1:T+H}) are sampled from a stationary conditional distribution model.

In a further embodiment of the method, the method further comprises training each of the stationary conditional distribution model, the prior model and the posterior model based on historical data {(yₜ, xₜ)}ₜ₌₁^{T}.

In a further embodiment of the method, training the posterior model is done using blocks of time in parallel.

In a further embodiment of the method, for training the posterior model, for the i-th time block out t∈(bᵢ, bᵢ₊₁], out of K blocks, δₜ is sampled in parallel across t according to: δₜ˜ [symbol] ((1−aₜ)⊙(mₜ, diag(sₜ²)); and χₜ computed according to: χₜ=Π_{v∈(b}_{ᵢ}_{, t]}aᵥ ⊙χ_{b}_{ᵢ}+Σ_{u∈(b}_{ᵢ}_{,t]} Σ_{v∈(u,t]}aᵥ ⊙δᵤ.

In accordance with the present disclosure, there is further provided a non-transitory computer readable medium having stored thereon computer program code that is executable by a processor and that, when executed by the processor, causes the processor to perform any of the methods described above.

In accordance with the present disclosure, there is provided a computer system comprising: a processor for executing instructions; and a memory storing instructions, which when executed by the processor configure the computer system to perform any of the methods described above.

This summary does not necessarily describe the entire scope of all aspects of the systems and methods for time-series forecasting. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a system for time-series forecasting;

FIG. 2 depicts components of a deep dynamic conditional forecasting (DynaConF) model for use in time-series forecasting;

FIG. 3 depicts the process of the time-series forecasting of the DynaConF model;

FIG. 4 depicts a method of training a DynaConF model;

FIG. 5 depicts a method of time-series forecasting using a trained DynaConF model; and

FIGS. 6A-6C depict experimental results of the DynaConF model.

### DESCRIPTION

A process for modeling and forecasting of non-stationary time series using a non-stationary model is described further herein. The statistics literature contains several related concepts of (non-)stationarity for time series, with weak and strong stationarity being the most widely used ones. Common to these variants of (non-)stationarity is that they are defined in terms of a stochastic process' joint distribution. For example, given a discrete time series {yₜ ∈ [symbol] }ₜ and any subset of time stamps {t₁, t₂, . . . , tₖ}, the time series may be considered strongly stationary if ∀τ∈ [symbol] :p(yₜ_{₁},yₜ_{₂}, . . . , yₜ_{ₖ}) p(yₜ_{₁}_{+τ}, yₜ_{₂}_{+τ}, . . . , yₜ_{ₖ}_{+τ}).

While non-stationarity with respect to a stochastic process' joint distribution is important in areas like statistics and econometrics, temporal forecasting relies more heavily on the properties of a time-series' conditional distribution p(yₜ|y_{t-B:t-1}, x_{t-B:t}), where y_{t-B:t-1}=(y_{t-B}, y₂, . . . , yₜ₋₁) and B [symbol] is the bounded history size of yₜ and can be arbitrarily large. xₜ ∈R^{Q} and contains auxiliary information. In general, this conditional distribution could vary significantly across time t as new evidence makes its way into the set of conditioning variable. Many existing models reduce the resulting complexity by making explicit conditional independence assumptions in the form of a bounded context window, e.g., an autoregressive model.

Examining popular time series models through the lens of this conditional distribution, on one end of the spectrum are simple auto-regressive (AR) models of order p, which make the time-invariant assumption p(yₜ|y_{1:t-1})=p(yₜ|y_{t-p:t-1}); and on the other end of the spectrum are various forms of latent variable models, such as state-space models (SSMs) and, more recently, deep learning models based on recurrent neural networks (RNNs). While the latter have the capability to directly model conditional distributions p(yₜ|y_{1:t-1}) with a growing number of conditioning variables, they usually make their own time-invariance assumptions, such as the recursive structure of the underlying dynamics. As a result, they do not respond well to time-variant changes in the conditional distribution, because (1) the model needs to be highly sensitive to the provided context, which increases the capacitive burden; and (2) the model cannot fully rely on the learned contextual relations, because the conditional distribution of the underlying ground truth process undergoes continual change.

The time-series forecasting described herein is able to provide modeling of non-stationary conditional distributions of time series. The forecasting uses a clean decoupling of the time-variant (non-stationary) part and the time-invariant (stationary) part of the distribution of the time series. The time-invariant part models a stationary conditional distribution, given some control variables, while the time-variant part only focuses on modeling the changes in this conditional distribution over time through those control variables. Using this separation, a flexible time-invariant conditional model is provided and inferences about how the model changes over time can be made efficiently. At test time or when used for forecasting, the model takes both the uncertainty of the conditional distribution as well as the non-stationarity into account when making predictions and adapts to the changes in the conditional distribution over time in an online manner. The modeling described herein is based on a Bayesian dynamic model that can adapt to conditional distribution changes and a deep conditional distribution model that can scale to large multivariate time series. The experiment results show that the model can adapt to non-stationary time series better than state-of-the-art deep learning solutions.

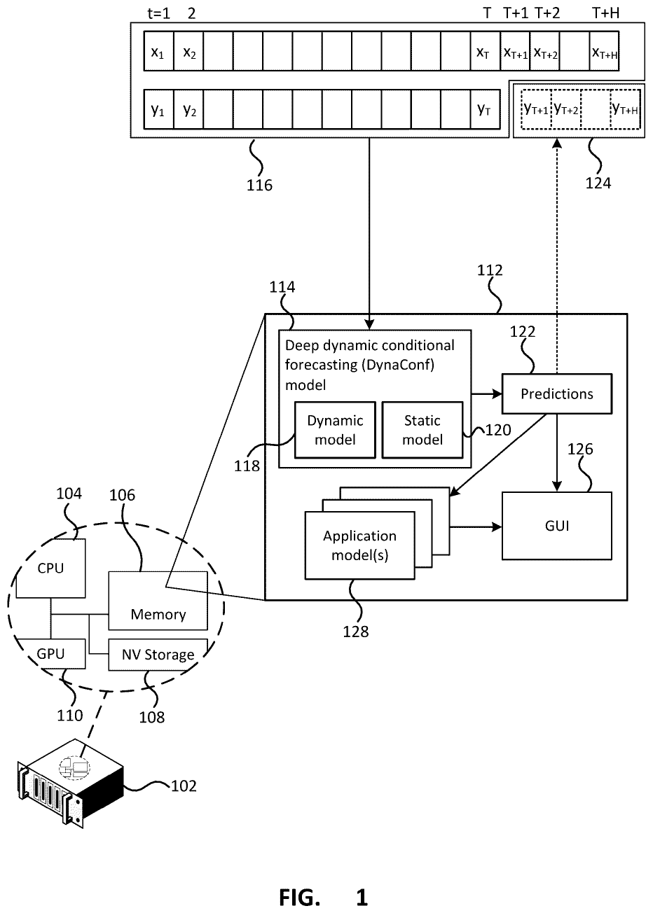

FIG. 1 depicts a system for time-series forecasting. The system may be provided by a computer system denoted generally by reference numeral 102. Although not depicted in FIG. 1, the computer system 102 may further include input and output devices such as a display, speakers, keyboard, mouse, etc. It will be appreciated that other types of input devices may be provided such as a touch screen.

The computer system 102 may contain one or more processors or microprocessors, such as a central processing unit (CPU) 104. The CPU 104 performs arithmetic calculations and control functions to execute software stored in a non-transitory internal memory 106, preferably random access memory (RAM) and/or read only memory (ROM), and possibly additional memory 108. The additional memory 108 is non-volatile may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 108 may be physically internal to the computer system, or both.

The one or more processors or microprocessors may comprise any suitable processing unit such as an artificial intelligence accelerator, programmable logic controller, a microcontroller (which comprises both a processing unit and a non-transitory computer readable medium), Al accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

The computer system 102 may also include other similar means for allowing computer programs or other instructions to be loaded. Such means can include, for example, a communications interface (not shown) which allows software and data to be transferred between the computer system and external systems and networks. Examples of communications interface can include a modem, a network interface such as an Ethernet card, a wireless communication interface, or a serial or parallel communications port. Software and data transferred via communications interface are in the form of signals which can be electronic, acoustic, electromagnetic, optical or other signals capable of being received by communications interface. Multiple interfaces, of course, can be provided on a single computer system.

Input and output to and from the computer system may be administered by the input/output (1/O) interface (not shown). The I/O interface may administer control of the display, keyboard, external devices and other such components of the computer system. The computer system may also include a graphical processing unit (GPU) 110. The GPU may also be used for computational purposes as an adjunct to, or instead of, the (CPU) 104, for mathematical calculations.

The various components of the computer system may be coupled to one another either directly or by coupling to suitable buses. The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The memory 106 may store instructions which when executed by the processor 104, and possibly the GPU 110, configure the system 102 to provide various functionality 112. The functionality 112 includes a deep dynamic conditional forecasting (DynaConF) model 114 that is implemented as a neural network. The DynaConF model receives a time-series of data 116 and uses model comprising both a dynamic model 118 and a static model 120 to generate one or more predictions 122 of the future of the time series 124. It will be appreciated that the different models referred to herein are implemented within the computer system as a neural network. The predictions may be displayed by graphical user interface (GUI) functionality and/or used in various downstream applications, depicted as application model(s) 128. The application models may use the future predictions for performing various actions depending upon the particular application. The results of the application model § 128 may also be displayed by the GUI functionality 126.

The DynaConF model is used to model a non-stationary time series, and may be used to forecast the time-series. The non-stationarity can happen in the conditional distribution (yₜ|y_{<t},x_{≤t}), where yₜ ∈ [symbol] ^{P}, xₜ ∈ [symbol] ^{Q}. Specifically, given the historical data {(xₜ, yₜ)}ₜ₌₁^{T}, the task is to fit the DynaConF model to the data and use it to perform forecast {yₜ}_{t+T+1}^{T+H}, {yₜ}_{t=T+H+1}^{T+H+H} continually with a horizon and step size at time steps H. For notational simplicity, it is assumed that xₜ only contains information that is known, or can be predicted, in advance at time t.

The goal of the DynaConF model is to model (yₜ|y_{<t}, x_{≤t}), and is done by providing a dynamic model and a static model. The following assumptions are made in the model so non-stationarity of the conditional distribution is well-defined.

The first assumption is that yₜ only depends on a bounded history of y and x for all t. That is, there exists B∈ [symbol] _{>0} such at for all time t

p(yₜ|y_{<t},x_{≤t})=p(yₜ|y_{t-B:t-1},x_{t-B:t}). (1)

That is, it is assumed yₜ can only depend on the history up to B time steps before but can change over time. This is not particularly restrictive assumption in practice, since there is usually a finite amount of training data while B can be arbitrarily large although usually not needed. Furthermore, it is assumed that the conditional distribution is from a distribution family that can be parameterized by θₜ ∈ [symbol] ^{M}, and

θₜ=f(y_{t-B:t-1},x_{t-B:t};ϕₜ,ψ), (2)

In equation (2) f: [symbol] ^{B×P}× [symbol] ^{(B+1)×Q}→ [symbol] ^{M} can be any parametric model including deep neural networks. The model has its own static parameters ψ, e.g., weights and biases in the layers of the neural network, but it is also modulated by the dynamic control variable ϕₜ∈ [symbol] ^{F}, which can change over time according to a specific dynamic process describe in detail further below. A property that may be provided by the model is that if ϕₜ stays the same at different time points, then the conditional distribution (yₜ|y_{t-B:t-1}, x_{t-B:t}) stays the same as well.

The DynaConF model separates the time-variant part of the model from the time-invariant part, instead of allowing every part of the whole model to vary across time. This simplifies the probabilistic inference needed to be done and improves the generalization of the learned model by allowing the time-invariant part to learn from time-invariant input and output relations with time-variant modulations.

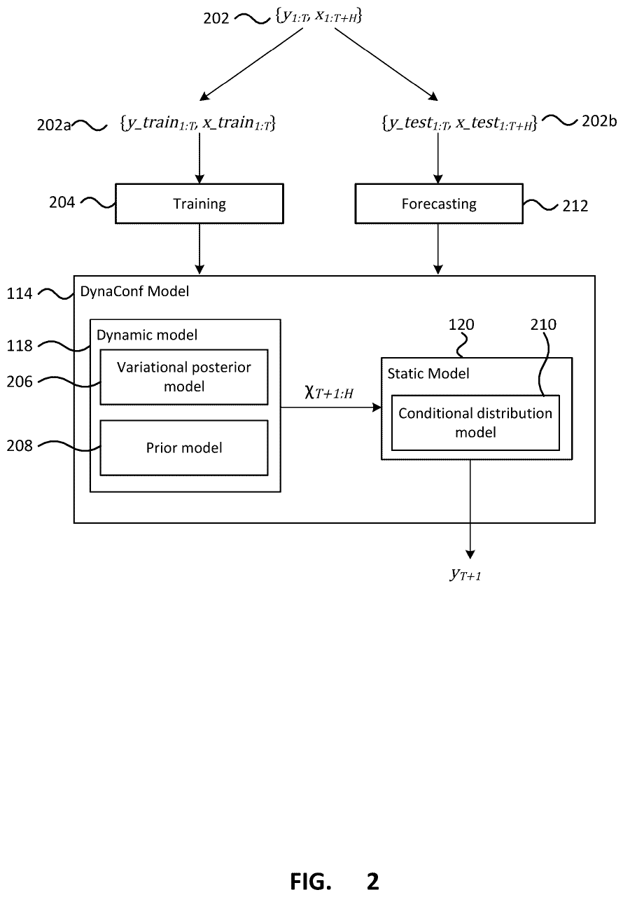

FIG. 2 depicts components of a Deep Dynamic Conditional Forecasting (DynaConF) model for use in time-series forecasting. As previously described, the DynaConF model 114 comprises a dynamic model 118 and a static model 120. The models may be trained and tested on a dataset 202. The dataset 202 can be split into a training set 202a used for training the models and a testing set 202b used for testing the trained models. The training and testing dataset 202 may be two segments of the same time series. The training 204 may determine the weightings of parameters of the models using the training data 202a. As depicted in FIG. 2 and described in further detail below, the dynamic model 118 may comprise a variational posterior model 206 and a prior model 208 to provide a control variable, depicted as x_{T+1:H} in FIG. 2, that provides information about how the conditional distribution changes over time. The static model 120 may comprise a conditional distribution model 210 that uses control variables provided by the dynamic model 118 to generate the predictions, depicted as y_{T+1} in FIG. 2. Forecasting functionality 212 may be used to apply time-series data to the trained model in order to generate predictions that can be used by other downstream processes. Although depicted in FIG. 2 as using different portions of a time-series for training and testing, namely {y_train_{1:T}, x_train_{1:T}} and {y_test_{1:T}, x_test_{1:T}}, the training and testing data sets are described using the same notation below. It will be appreciated that the training and testing sets may be from the same set but of different sizes. When forecasting, the same data may be used for both training and forecasting with the training set being a subset of the forecasting.

As described above, the DynaConF model models non-stationary conditional distributions by splitting the model into a stationary conditional distribution and a dynamic model that models changes to the conditional distribution over time.

How the conditional distribution is modeled at a fixed time point, i.e., when non-stationarity is not involved is first described. For a specific time point t, it is desired to model the conditional distribution p(yₜ|y_{t-B:t-1}, x_{t-B:t}). For notation simplicity, y_{t-B:t-1} is absorbed into x_{t-B:t} and the distribution denoted as p(yₜ|x_{t-B:t}).

A deep neural network g is used to summarize the historical observations y_{t-B:t-1} and contextual features x_{t-B:t}. For example, if B is small, it may be possible to use a multi-layer perceptron (MLP). If B is large, it may be possible to use a recursive neural network (RNN). The consideration of whether B is large or small may be subjective and may be considered to be based on various factors including the complexity of the dataset, the available computational resources and the acceptable performance. For example, B may be considered small when it is approximately 1, 10 or 100, however it may also depend upon how many dimensions are in the time series and/or how large the GPU memory is. In any case, the network g is to summarize the historical and contextual information of x_{t-B:t} into a fixed-dimension vector hₜ ∈ [symbol] ^{D} as:

hₜ=g(y_{t-B:t-1},x_{t-B:t}). (3)

The parameters of this neural network g are part of the model parameters, ψ of eq. (2), and learned jointly with other parameters. A distinction of the current conditional model using an RNN compared to a typical deep time series models using an RNN is that the latter keep rolling the RNN over time continuously to model the dynamics of the time series. In contrast, the current purely uses the RNN to summarize the historical information for the conditional distribution and therefore apply it in a time-invariant manner for each t−B:t.

The distribution of yₜ may be constructed such that each dimension, i, of yₜ denoted y_{t,i} is conditionally independent from the others given hₜ as this can help the learning and inference algorithms to scale better with the dimensionality of yₜ. From hₜ, the parameters of the distribution θₜ may be constructed in two steps. First, hₜ is projected or transformed into P vectors of dimension E, z_{t,i}∈ [symbol] ^{E}, E<D, as:

z_{t,i}=tan h(W_{z,i}hₜ+b_{z,i}),∀i=1, . . . ,P (4)

In equation (4) W_{z,i}∈ [symbol] ^{E×D}, b_{z,i}∈ [symbol] ^{E}. Each z_{t,i} corresponds to one dimension of the observation yₜ.

Then a simple linear function combined with appropriate non-linear transformations may be used to get the distribution parameters θ_{t,i} of each dimension y_{t,i}. Specifically, if a normal distribution for yₜ with a diagonal covariance matrix is assumed, so y_{t,i}˜ [symbol] (μ_{t,i}, σ_{t,i}²) and θ_{t,i}:=(μ_{t,i}, σ_{t,i}²) then the mean μ_{t,i}∈ [symbol] ^{P} and covariance σ_{t,i}∈ [symbol] ^{P×P} for each dimension i are

μ_{t,i}=w_{μ,i}^{T}z_{t,i}+b_{μ,i},σ_{t,i}=exp(w_{σ,i}^{T}z_{t,i}+b_{σ,i}) (5)

In equation (5) w_{μ,i}∈ [symbol] ^{E}, w_{σ,i}∈ [symbol] ^{E}. Although the exponential function is used in equation (5), other non-linear transformations may be used, such as the soft-plus function. W_{μ}∈ [symbol] ^{P×E} and b_{μ}∈ [symbol] ^{P} is used to denote the result of stacking w_{μ,i}^{T} and b_{μ,i} over i, and similarly for W_{σ}, b_{σ}, zₜ, μₜ, σₜ. Although not described, other distribution families can be used as well, if they are more suited for the data, especially if modeling the covariance structure between different dimensions of y is important. Here, a simpler distribution assumption is taken with a diagonal covariance, as it helps the dynamic model and the learning algorithm to scale better regarding the dimensionality of y.

The above has described how it is possible to model the conditional distribution at a fixed time point. To model the conditional distributions across time points and take into account the non-stationarity, which parameters to include in the control variable ϕₜ ∈ [symbol] ^{F} that changes over time and modulates the conditional distribution are specified.

It is assumed that the network g that summarizes historical and contextual information is time-invariant, but the linear functions that maps zₜ to the distribution parameters θₜ is time-variant. Specifically, ϕₜ: ={W_{μ}, b_{μ}, W_{σ}, b_{σ}} for the normal distribution family.

While ϕₜ may include parameters such as W_{μ}, b_{μ}, W_{σ}, b_{σ}, not all parameters need to be included. For example, ϕₜ:=vec(W_{μ}). That is ϕₜ is the vectorization of W_{μ}. Recalling that W_{μ} transforms zₜ into the mean μₜ of yₜ, zₜ may be considered as a summary of the information in the conditioning variables (y_{t-B:t-1}, x_{t-B:t}). By allowing W_{μ} to be different at each time point t the conditional mean of yₜ, E[yₜ|y_{t-B:t-1}, x_{t-B:t}], can change as well. It is possible to allow W_{σ} to change over time to model a time-variant conditional variance as well, but focusing on W_{μ} reduces the dimensionality of ϕₜ and enables more efficient inference utilizing, for example Rao-Blackwellization.

ϕₜ may be decomposed into a dynamic stochastic process χₜ ∈ [symbol] ^{F} and a static vector b_{ϕ}∈ [symbol] as

ϕₜ=χₜ+b_{ϕ}. (6)

Intuitively, b_{ϕ} captures the global information of ϕₜ and acts as a baseline, while χₜ captures the time-variant changes of ϕₜ relative to b_{ϕ}.

The following generative process is used for χₜ:

πₜ˜ [symbol] (λ), (7)

∈ₜ˜ [symbol] (0,Σ_{d}), (8)

χₜ˜ [symbol] (0,Σ₀), if πₜ=0, (9)

χₜ=χₜ₋₁+∈ₜ, if πₜ=1, (10)

In the above, [symbol] and [symbol] denote the Bernoulli and normal distributions respectively. πₜ determines between generating current χₜ as a new sample drawn from a global distribution [symbol] (0, Σ₀) or as a continuation from the previous χₜ₋₁ following a simple [symbol] stochastic process such as random walk. χₜ is able to change both continuously, when πₜ=1 through the random walk, and discontinuously, when πₜ=0, through the global distribution, which captures the variety of possible changes of χₜ in its parameter Σ₀.

It is assumed that the process χₜ starts at t=B, since it controls the conditional distribution, whose first observation occurs at t=B+1. For the initial χ_{B}, it is assumed it is generated from [symbol] (0, Σ₀) as well, since the intention is that [symbol] (0, Σ₀) captures the generic distribution the model should fall back to from time to time, and without prior knowledge at t=B, it is natural to use that distribution.

χₜ ∈ [symbol] ^{F}, with F=P×E. χₜ can be separated along the P dimensions of yₜ into P groups. For each i=1, . . . , P it is possible to define χ_{t,i} ∈ [symbol] ^{E} according to equations (7)-(10). The final χₜ may be the concatenation of χ_{t,i} for all i. The intuition is to allow the group of components of χₜ modulating each dimension of yₜ to change independently from the others, corresponding to the conditional independence assumption, so that a subset of dimensions of y can be sampled in each iteration during training to scale to high-dimensional time series.

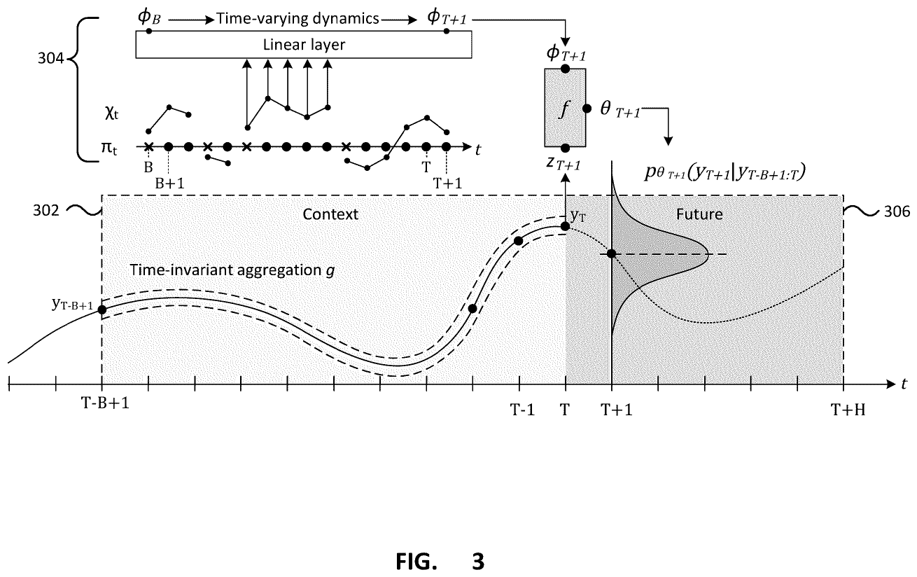

FIG. 3 depicts the process of the time-series forecasting of the DynaConF model. The process depicted in FIG. 3 provides a clean decoupling between the stationary conditional distribution modeling, depicted as context 302, and non-stationary dynamics modeling 304. The parameters of the conditional distribution 306 are predicted by aggregating the time-invariant local context z 308 and modulating this context with time-variant global dynamics ϕ which are driben by a random walk χ 310 with Bernoulli-restarts π 312. The conditional distribution, with parameters determined by modulating the time-invariant context with the time-variant dynamics, may be used to predict future values of y.

The separation of model into a dynamic model and a static model is described above. The models are trained using historical data as described further below.

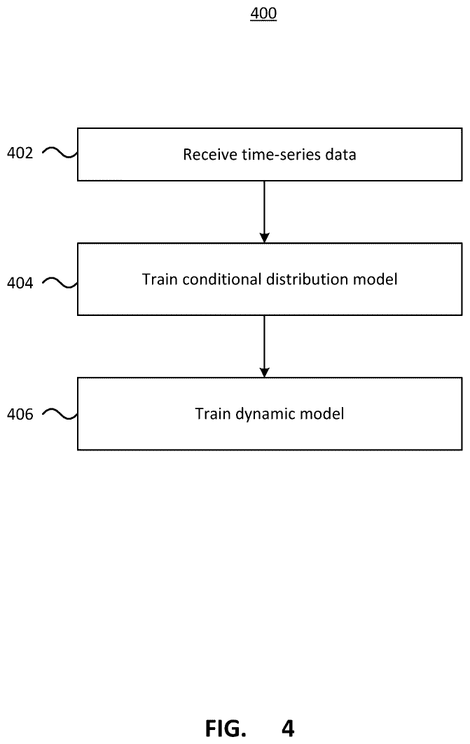

FIG. 4 depicts a method of training a DynaConF model. The method 400 receives a time-series of data (402). The stationary conditional distribution model is trained using the received time-series of data (404). Similarly, the variational posterior model and structured prior model are trained using the received time-series of data (406). The training of the models is described in further detail below.

All the parameters in the conditional distribution model and the prior model are learned by fitting the whole model to the historical training data {(yₜ, xₜ)}ₜ₌₁^{T}. The model is trained by maximizing the marginal log-likelihood, where the latent variables χₜ are marginalized out. Given a trajectory of χ_{B:T}, the conditional log-likelihood is

log p(y_{B+1:T}|y_{1:B},x_{1:T},χ_{B:T})=Σ_{t=B+1}^{T} log p(yₜ|y_{t-B:t-1},x_{t-B:t},χₜ). (11)

Marginalizing out χₜ gives us the log-likelihood being maximized

log p(y_{B+1:T}|y_{1:B},x_{1:T})=log ∫p(y_{B+1:T}|y_{1:B},x_{1:T},χ_{B:T})p(χ_{B:T})χ_{B:T}. (12)

Since the integral of (12) is intractable, a variational distribution q(χ_{B:T}) is introduced and the following variational lower-bound of the log-likelihood in (12) is maximized.

$$ℒ := {E}_{q} [ log p ( {y}_{B + 1 : T} \vert {y}_{1 : B} , {x}_{1 : T} , {χ}_{B : T} ) ] + {E}_{q} [ log \frac{p ( {χ}_{B : T} )}{q ( {χ}_{B . T} )} ] \leq log p ( {y}_{B + 1 : T} \vert {y}_{1 : B} , {x}_{1 : T} ) . \qquad ( 13 )$$

The variational distribution q(χ_{B:T}) is constructed as an autoregressive process. A simple Normal distribution may be assumed at each time step for efficient sampling and back-propagation. At the beginning, it is assumed q(χ_{B})=p(χ_{B}). Then conditioned on the previous χₜ₋₁, the current distribution is recursively defined as

q(χₜ|χₜ₋₁)= [symbol] (aₜ⊙χₜ₋₁+(1−aₜ)⊙mₜ,diag(sₜ²)),∀t=B+1, . . . ,T, (14)

In equation (14) aₜ, mₜ, sₜ ∈ [symbol] ^{F} are all variational parameters. Intuitively, aₜ acts as a gate that chooses between continuing from the previous χₜ₋₁ with noise [symbol] (0, diag(sₜ²)), or a new distribution [symbol] (mₜ, diag(sₜ²)) for the mean of the current χₜ.

It is noted that both terms in (13) can factorize along the time points t=B+1, . . . , T as follows

$$ℒ = {E}_{q ( {χ}_{B : T} )} [ {\sum }_{t = B + 1}^{T} log p ( {y}_{t} \vert {y}_{t - B : t - 1} , {x}_{t - B : t} , {χ}_{t} ) ] + {E}_{q ( {χ}_{B : T} )} [ {\sum }_{t = B + 1}^{T} log \frac{p ( {χ}_{t} \vert {χ}_{t - 1} )}{q ( {χ}_{t} \vert {χ}_{t - 1} )} ] = {\sum }_{t = B + 1}^{T} {E}_{q ( {χ}_{t} )} [ log p ( {y}_{t} \vert {y}_{t - B : t - 1} , {x}_{t - B : t} , {χ}_{t} ) ] + {\sum }_{t = B + 1}^{T} {E}_{q ( {χ}_{t - 1 : t} )} [ log \frac{p ( {χ}_{t} \vert {χ}_{t - 1} )}{q ( {χ}_{t} \vert {χ}_{t - 1} )} ] . \qquad ( 15 )$$

This is an important property that is made use of later for the learning algorithm. In the above derivation, p(χ_{B})=q(χ_{B}) were canceled out due to the definition of q(χ_{B}). The expectations in this equation can be evaluated by Monte-Carlo sampling from q(χ) with the reparameterization trick for back-propagation described in Kingma and Welling, 2014 which is incorporated herein by reference in its entirety.

In practice, sequential sampling in the autoregressive posterior could be inefficient. A generalized posterior can be developed by replacing the autoregressive chain with multiple moving-average blocks combined with autoregressive dependencies between consecutive blocks, where sampling within each block can be carried out in parallel. Specifically, for the i-th time block, t∈(bᵢ, bᵢ₊₁], where b₁=B, b_{K+1}=T, bᵢ<bᵢ₊₁, out of K blocks δₜ may be sampled in parallel across t according to:

δₜ˜ [symbol] ((1−aₜ)⊙(mₜ,diag(sₜ²)) (16)

With δₜ, χₜ may be computed according to:

χₜ=Π_{v∈(b}_{ᵢ}_{,t]}aᵥ⊙χ_{b}_{ᵢ}+Σ_{u∈(b}_{ᵢ}_{,t]}Π_{v∈(u,t]}aᵥ⊙δᵤ (17)

Equation (17) was used as the posterior model in experiments that were performed.

In contrast to existing time series models, the current model utilizes a flexible variational posterior with a large number of parameters in the order of O(T) and a structured prior model to account for conditional distribution changes over time. However, jointly optimizing over these variational parameters and the large number of parameters in the conditional distribution model itself using stochastic gradient descent can be prohibitively demanding on the computational resources, especially GPU memory. Instead, an alternative optimization procedure is described below to learn these parameters.

Specifically, instead of optimizing by stochastic gradient descent (SGD) over all parameters in both the conditional distribution model and the prior and variational posterior model, the model is learned by alternately optimizing the parameters in the conditional distribution model and the prior and variational posterior models. For the former, the conditional distribution model is conditioned on the current posterior model while optimizing on randomly sampled sub-sequences from the time series with stochastic gradient descent (SGD). For the latter, the conditional distribution model is fixed, and the variational posterior model rolled across the entire time series sequentially together with the prior model. Then a single gradient update is performed on the whole sequence. This part can also be done with truncated back-propagation-through-time (BPTT), when GPU memory is a constraint.

Once the models have been trained, they can be used to forecast the future data of the time-series as described further below.

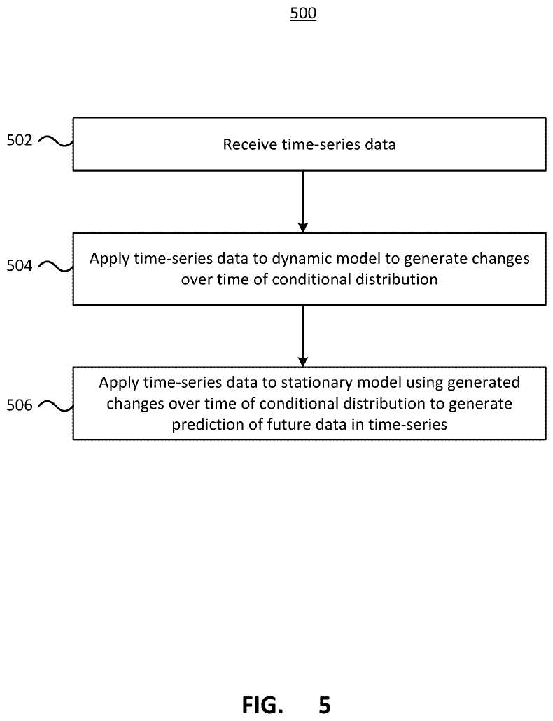

FIG. 5 depicts a method of time-series forecasting using a trained DynaConF model. The method 500 receives time-series data (502) which is applied to the dynamic model to generate control variables based on changes over time of the conditional distribution of the received time-series (504). The time-series data is applied to the static model using the control variables about the charges over time of the conditional distribution to generate predictions of the future data in the time-series (506). The forecasting is described in further detail below.

At test time or when forecasting, the given time-series data comprises observations in the past y_{1:T} and the features in both the past and the next H steps {xₜ}ₜ₌₁^{T+H}. It is noted that the features for the next H steps may be known at the present time or be able to be determined or estimated. If the features are not known or can't be determined only the past features may be used. Given the time-series data, the forecasting attempts to make predictions about y_{T+1:H} for the next H steps. In forecasting, inferences are made about the conditional distribution p(y_{T+1:H}|y_{1:T}, x_{1:T+H}), and based on the modeling assumptions, this can be computed as

p(y_{T+1:T+H}|y_{1:T},x_{1:T+H})=∫p(y_{T+1:T+H}|y_{T+1-B:T},x_{T+1-B:T+H},χ_{T+1:T+H})p(χ_{T+1:T+H}|y_{1:T},x_{1:T})dχ_{T+1:T+H}. (18)

The first factor in the integrand can be computed recursively by step-by-step predictions based on the conditional distribution model given χ_{T+1:T+H}

p(y_{T+1:T+H}|y_{T+1-B:T},x_{T+1-B:T+H},χ_{T+1:T+H})=Π_{t=T+1}^{T+H}p(y_{t-B:t-1}x_{t-B:t},χₜ). (19)

The second factor in the integrand can be further factorized into

p(χ_{T+1:T+H}|y_{1:T},x_{1:T})=∫p(χ_{T+1:T+H}|χ_{T},y_{1:T},x_{1:T})p(χ_{T}|y_{1:T},x_{1:T})dχ_{T} (20)

Particle filtering may be used to infer p(χ_{T}|y_{1:T}, x_{1:T}), so the model can keep adapting to new changes in an online manner. πₜ and χₜ can be jointly inferred with particles representing πₜ and closed form inference of χₜ. Then, the prior model may be used to sample trajectories of χ_{T+1:T+H} conditioned on the posterior samples of χₜ=p(χ_{T}|y_{1:T}, x_{1:T}). Then given the samples of χ_{T+1:T+H} conditioned on y_{1:T}, x_{1:T}, the trajectories of P(y_{T+1:T+H}|y_{T+1-B:T}, x_{T+1-B:T+H},χ_{T+1:T+H}) can be sampled using the above step-by-step predictions of the conditional distribution model.

The above time-series forecasting model may be used for forecasting purposes on time-series of data that is a non-stationary time-series. The model was trained, tested and compared to other time-series forecasting techniques.

The DynaConF approach described above was compared to other techniques with 2 univariate and 8 multivariate time series models, both on synthetic and real-world datasets. Table 1 below indicates the baseline models used in the comparisons and their properties. It is noted that DeepVAR is also called Vec-LSTM in previous works. For the current model, two different variants were considered. The first used only the static conditional distribution (StatiConF) and the second included the dynamic updates to the conditional distribution (DynaConF) as described above. In both cases different encoder architectures were experimented with. For synthetic data, either a two-layer MLP with 32 hidden units (*-MLP) or a point-wise linear+tan h mapping (*-PP) was used as the encoder. For real-world data, an LSTM was used as the encoder.

| Model | Synthetic | Real-World | Multivariate |
|---|---|---|---|
| DeepAR | Yes | | |
| DeepSSM | Yes | | |
| TransformerMAF | Yes | Yes | Yes |
| DeepVAR (I)nd. | Yes | Yes | Yes |
| DeepVAR (C)opula | | Yes | Yes |
| GP-Scaling | | Yes | Yes |
| GP-Copula | | Yes | Yes |
| LSTM-NVP | | Yes | Yes |
| LSTM-MAF | | Yes | Yes |
| TimeGrad | | Yes | Yes |

Table 1 of comparison models.

For the experiments on synthetic data four conditionally non-stationary stochastic processes were simulated for T=2500 time steps. The first 1000 steps were used as training data, the next 500 steps as validation data, and the remaining 1000 steps as test data. The following datasets were used:
(AR(1)—Flip) An AR(1) process was simulated, yₜ=wₜyₜ₋₁+∈, ∈˜ [symbol] (0,1), but its coefficient wₜ was resampled from a uniform categorical distribution over {−0.5, +0.5} every 100 steps to introduce non-stationarity.
(AR(1)—Dynamic) The same process as above was simulated but now wₜ was resampled from a continuous uniform distribution [symbol] (−1, −1) every 100 steps. [symbol]
(AR(1)— Sin) The same process as above was simulated but now rwₜ was resampled according to wₜ=sin(2π/T). Different from the two processes above, this process has a continuously changing non-stationary conditional distribution with its own time-dependent dynamics.
(VAR(1)—Dynamic) This process can be viewed as a multivariate generalization of AR(1)—Dynamic and is used in the comparisons with multivariate baselines. A four-dimensional VAR process is used with an identity noise matrix. Similar to the univariate case, the entries of the coefficient matrix are resampled from a continuous uniform distribution [symbol] (−0.8, −0.8) every 250 steps. In addition, the stability of the resulting process is ensured by computing the eigenvalues of the coefficient matrix and discard it if its largest absolute eigenvalue is greater than 1.

For univariate data (AR(1)—Flip/Sin/Dynamic), the current approach was compared with the two univariate baselines DeepAR and DeepSSM. For multivariate data (VAR(1)—Dynamic), most baselines are redundant because their focus is on better observation models, while the underlying temporal backbone is similar. Since the current synthetic observation distributions are simple, the current process is compared with two model families that differ in their temporal backbone: DeepVAR (RNN backbone) and TransformerMAF (Transformer backbone). A context window size of 200 is used to give the model access to the information needed to infer the current parameter of the true conditional distribution. Increasing the window size to 500 on VAR(1)—Dynamic was tried but did not see performance improvements. Additionally, the unnecessary default input features of these models was removed to prevent overfitting.

On synthetic data, most baseline hyperparameters are kept at their default values but make the following changes to account for properties of the synthetic data: (1) To reduce overfitting any unnecessary input features are removed from the models and only past observations are used with time lag 1 as input. (2) To allow the models to adapt to changes in the conditional distribution the context window size is increased to 200. This allows the models to see enough observations generated with the latest ground-truth distribution parameters, so the models have the necessary information to adapt to the current distribution. For VAR(1)—Dynamic, extending it to 500 was tried, but it did not improve the performance. (3) DeepSSM allows modeling of trend and seasonality, but since the synthetic data do not have those, those components are removed from the model specification to avoid overfitting; (4) DeepVAR allows modeling of different covariance structures in the noise, such as diagonal, low-rank, and full-rank. Since the synthetic data follow a diagonal covariance structure in the noise, that is explicitly specified in DeepVAR. On synthetic data, the validation set is used to early stop and choose the best model for both the baselines and StatiConF. For DynaConF, training continues as long as the loss is decreasing on the training set. 50 updates per epoch are performed. 32 hidden units are used for the 2-layer MLP encoder.

All experiments were run for three different random seeds independently and the mean and standard deviation of each evaluation metric for each model was calculated and reported. On synthetic datasets, 1000 sample paths were used to empirically estimate the predicted distributions for all models. On real-world datasets, 100 sample paths were used.

Three evaluation metrics were used: mean squared error (MSE), and continuous ranked probability score (CRPS). Assume that y is observed at time t but a probabilistic forecasting model predicts the distribution of y to be F. MSE is widely used for time series forecasting, and for a probabilistic forecasting model, where the mean of the distribution is used for point prediction, it is defined as

MSE(F,y)=(E_{z˜F}[z]−y)² (21)

for a single time point t and averaged over all the time points in the test set.

CRPS has been used for evaluating how close the predicted probability distribution is to the ground-truth distribution and is defined as:

CPRS(F,Σᵢyᵢ)= [symbol] (F(z)− [symbol] [y≤z])²dz (22)

for a single time point t and averaged over all the time points in the test set, where [symbol] denotes the indicator function. Generally, F(z) can be approximated by the empirical distribution of the samples from the predicted distribution. Both MSE and CRPS can be applied to multivariate time series by computing the metric on each dimension and then averaging over all the dimensions.

For evaluation a rolling-window approach was used with a window size of 10 steps. The final evaluation metrics are the aggregated results from all 100 test windows. For univariate data the continuous ranked probability score (CRPS) is reported, a commonly used score to measure how close the predicted distribution is to the true distribution. In the results lower values indicate better performance.

The results on synthetic data are shown in Tables 2 and 3. For univariate data, the full model (DynaConF) outperforms its ablated counterpart (StatiConF) by 2.0%-12.3%, validating the importance of the dynamic adaptation to non-stationary effects. DynaConF—PP is also superior to all univariate baselines, with its closest competitor DeepAR—10 behind by an average of 6.1%. Furthermore, it is noted that the DynaConF model with the pointwise encoder tends to outperform the MLP encoder, both for the ablated and full model. For multivariate data similar trends were observed. Here, the full model (DynaConF—PP) performs 24.3% (CRPS) better than the ablated model with static conditional distribution (StatiConF—PP) and 22.6% (CRPS) better than the best-performing baseline (DeepVAR—160). As before, pointwise encoders tend to perform better than MLP encoders. Since for synthetic data the ground-truth models are available, the corresponding scores are included as a reference and upper bound in terms of performance.

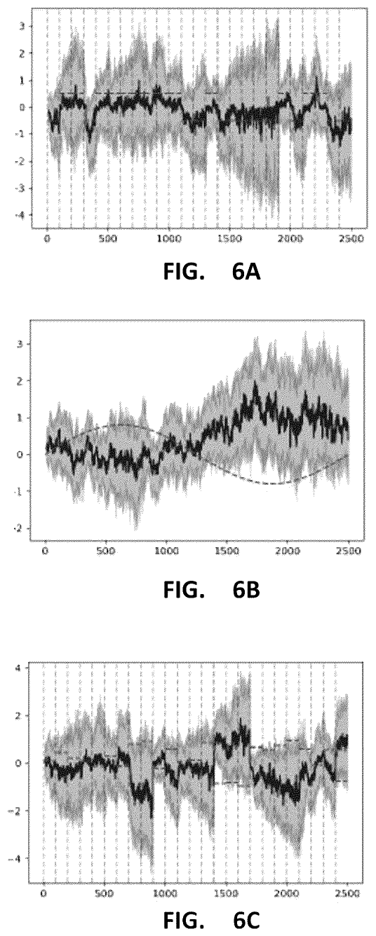

FIGS. 6A-6C show qualitative results of the model on AR(1)—Flip/Sin/Dynamic. FIG. 6A depicts results for AR(1)—Flip, FIG. 6B depicts results for AR(1)— Sin and FIG. 6C depicts results for AR(1)—Dynamic. Note that because the encoder in the current model is non-linear, the inferred ϕₜ does not necessarily correspond to the original parameter. However, it can clearly be seen how it differs for Sin (continuous changes) vs Flip/Dynamic (discrete jumps) and how it tracks the ground-truth up to scale/sign. The dashed lines in FIGS. 6A-6C show the ground-truth parameters of the conditional distribution varying over time. The curves and bands are the medians and 90% confidence intervals of the posterior.

TABLE 2

| | AR(1)-F | | AR(1)-S | | AR(1)-D | |
|---|---|---|---|---|---|---|
| Method | CRPS | MSE | CRPS | MSE | CRPS | MSE |
| GroundTruth | 0.731 | 1.2 | 0.710 | 1.6 | 0.624 | 2.1 |
| DeepAR - 10 | 0.741 | 1.3 | 0.764 | 1.8 | 0.768 | 3.2 |
| DeepAR - 40 | 0.740 | 1.3 | 0.776 | 1.8 | 0.820 | 3.6 |
| DeepAR - 160 | 0.740 | 1.3 | 0.774 | 1.8 | 0.801 | 3.5 |
| DeepSSM | 0.755 | 1.3 | 0.761 | 1.8 | 0.803 | 3.3 |
| StatiConF - MLP | 0.753 | 1.3 | 0.784 | 1.9 | 0.764 | 3.3 |
| StatiConF - PP | 0.752 | 1.3 | 0.763 | 1.8 | 0.783 | 3.3 |
| DynaConF - MLP | 0.750 | 1.3 | 0.727 | 1.6 | 0.691 | 2.6 |
| DynaConF - PP | 0.737 | 1.2 | 0.721 | 1.6 | 0.687 | 2.6 |

Univariate - AR(1)-*: F = Flip; S = Sin; D = Dynamic

TABLE 3
Multivariate: VAR(1) - Dynamic

| Method | CRPS | MSE |
|---|---|---|
| GroundTruth | 0.496 | 2.8 |
| DeepVAR - 10 | 0.797 | 8.4 |
| DeepVAR - 40 | 0.792 | 8.4 |
| DeepVAR - 160 | 0.787 | 8.3 |
| TransformerMAF-8 | 0.800 | 8.5 |
| TransformerMAF-32 | 0.806 | 8.5 |
| TransformerMAF-128 | 0.866 | 9.4 |
| StatiConF - MLP | 0.806 | 8.5 |
| StatiConF - PP | 0.805 | 8.5 |
| DynaConF - MLP | 0.762 | 7.9 |
| DynaConF - PP | 0.609 | 4.5 |

In testing with real-world data, the method described herein is evaluated on six publicly available datasets:
Exchange: daily exchange rates of 8 different countries from 1990 to 2016;
Solar solar power production in 10-minute intervals of 137 PV plants in 2006;
Electricity: hourly electricity consumption of 370 customers from 2012 to 2014;
Traffic: hourly occupancy data at 963 sensor locations in the San Francisco Bay area;
Taxi: rides taken in 30-minute intervals at 1214 locations in New York City in January 2015/2016;
Wikipedia: daily page views of 2000 Wikipedia articles.

For the real-world data the same train/test splits and the same input features, such as time of the day, as previous works with published code and results were used. For the current method, first the StatiConF model was trained and then its learned encoder was reused in DynaConF, so the learning of DynaConF is focused on the dynamic model. The models use a two-layer LSTM with 128 hidden units as the encoder, except for the 8-dimensional Exchange data, where the hidden size is 8. Again it is noted that, different from DeepVAR or LSTM-MAF, LSTM as an encoder of (y_{t-B:t1}, x_{t-B,t}) only so that it is restarted at every time step.

On real-world data, the last 10% of the training time period is used as the validation set and the learning rate, number of training epochs, and model sizes are chosen using the performance on the validation set for StatiConF. After training StatiConF, its encoders are reused in DynaConF, so it only needs to learn the dynamic model. For DynaConF, the same validation set is used to choose the number of training epochs and use 0.01 as the fixed learning rate.

For the models, Adam is used as the optimizer with the default learning rate of 0.001 unless the learning rate is chosen using the validation set. The dimension of the latent vector z_{t,i} is set to E=4 across all the experiments.

Because of the diversity of the real-world datasets, further techniques are applied to stabilize training. Specifically, for all datasets, the mean and standard deviation are used to shift and scale each dimension of the time series. For Exchange, the mean and standard deviation of the recent past data are used in a moving context window. For the other datasets, the global mean and standard deviation of each dimension computed using the whole training set is used. In all cases, for forecasting, the output from the model is inversely scaled and shifted back for evaluation. These design choices were made based on the performance on the validation sets.

For real datasets, extreme values or outliers may cause instability during training. Winsorization is optionally applied using the quantiles (0.025 and 0.975) computed from the recent past data in a moving context window on Traffic and Wikipedia, based on the results on the validation sets.

Table 4 depicts the results. As can be seen, for different datasets and different evaluation metrics, the relative performance of each method can be different. This shows the diversity of these datasets and that different models may benefit from dataset-specific structure in different ways. However, DynaConF achieves the best performance more often than all the other baselines. Where it does not outperform, its performance is competitive consistently, unlike the baselines, whose relative performance (compared to others) varies significantly across datasets. It is also noted that the full model, DynaConF, which adapts to changes in the conditional distribution consistently outperforms the ablated model, StatiConF, which only models a static conditional distribution, except for electricity, where the performance is similar. This shows the effectiveness of modeling the dynamic changes in the conditional distribution.

TABLE 4

| | Exchange | | Solar | | Electricity | | Traffic | | Taxi | | Wikipedia | |
|---|---|---|---|---|---|---|---|---|---|---|---|---|
| | | MSE | | MSE | | MSE | | MSE | | MSE | | MSE |
| Method | CRPS | [e − 4] | CRPS | [e + 2] | CRPS | [e + 5] | CRPS | [e − 4] | CRPS | [e + 1] | CRPS | [e + 7] |
| DeepVAR (I) | 0.013 | 1.6 | 0.434 | 9.3 | 1.059 | 2.1 | 0.168 | 6.3 | 0.586 | 7.3 | 0.379 | 7.2 |
| DeepVAR (C) | 0.009 | 1.9 | 0.384 | 29 | 0.084 | 55 | 0.165 | 15 | 0.416 | 5.1 | 0.247 | 3.8 |
| GP-scaling | 0.017 | 2.9 | 0.415 | 11 | 0.053 | 1.8 | 0.140 | 5.2 | 0.346 | 2.7 | 1.549 | 5.5 |
| GP-Copula | 0.008 | 1.7 | 0.371 | 9.8 | 0.056 | 2.4 | 0.133 | 6.9 | 0.360 | 3.1 | 0.236 | 4.0 |
| LSTM-NVP | 0.010 | 2.4 | 0.365 | 9.1 | 0.059 | 2.5 | 0.172 | 6.9 | 0.327 | 2.6 | 0.333 | 4.7 |
| LSTM-MAF | 0.012 | 3.8 | 0.378 | 9.8 | 0.051 | 1.8 | 0.124 | 4.9 | 0.314 | 2.4 | 0.282 | 3.8 |
| TransformerMAF | 0.012 | 3.4 | 0.368 | 9.3 | 0.052 | 2.0 | 0.134 | 5.0 | 0.377 | 4.5 | 0.274 | 3.1 |
| TimeGrad | 0.009 | 2.5 | 0.367 | 8.8 | 0.049 | 1.97 | 0.110 | 4.2 | 0.311 | 2.6 | 0.261 | 3.8 |
| StatiConF | 0.009 | 2.3 | 0.363 | 8.2 | 0.057 | 1.8 | 0.112 | 4.8 | 0.301 | 2.2 | 0.339 | 4.0 |
| (Current) | | | | | | | | | | | | |
| DynaConF | 0.009 | 2.0 | 0.355 | 8.0 | 0.052 | 1.7 | 0.111 | 4.8 | 0.301 | 2.2 | 0.259 | 3.7 |
| (Current) | | | | | | | | | | | | |

results on real-world dataset

The current model was also tested against five state-of-the-art baselines on two publicly available datasets:
Walmart: weekly sales of 45 Walmart stores from February 2010 to October 2012; and
StackOverflow: monthly counts of questions on 69 topics in machine learning on StackOverflow from 2009 to 2019.

For both datasets, the last 10% of the training time period was used as the validation set to tune the hyperparameters of all the models. The results are depicted in Table 5 below.

TABLE 5
results on additional real world datasets

| | Walmart | | StackOverflow | |
|---|---|---|---|---|
| Method | CRPS | MSE [e−1] | CRPS | MSE [e+2] |
| DeepVAR | 0.793 | 3.282 | 0.834 | 2.773 |
| GP-Copula | 0.557 | 2.761 | 0.667 | 2.453 |
| LSTM-MAF | 0.685 | 4.275 | 0.821 | 2.729 |
| TransformerMAF | 0.638 | 3.651 | 0.702 | 2.599 |
| TimeGrad | 0.604 | 3.190 | 0.717 | 2.629 |
| StatiConF | 0.573 | 3.146 | 0.758 | 2.688 |
| (current) | | | | |
| DynaConF | 0.512 | 2.497 | 0.258 | 0.263 |
| (current) | | | | |

The DynaConF model shows much better performance compared to the baseline models. It is noted that the test time periods have drastic changes in the conditional distributions, which the DynaConF handles well. It can be seen from the experimental results that when the conditional distribution of the time series remains stable, DynaConF can perform competitively compared to baselines that do not explicitly model conditional distribution changes, however, when the conditional distribution changes, the DynaConF model can provide a significant improvement over other models.

The above has described systems and methods that may be used for the time-series forecasting when the time-series is non-stationary. The forecasting may be applied to a number of different applications and data types, including, for example electricity usage, exchange rates, traffic patterns, solar, taxi, Wikipedia among others. As described above, the models may be trained on existing datasets and then the trained models may be used to forecast or predict the time series in the future. The forecast or predictions may then be used by downstream applications for example in determining actions to perform, determining how to control systems or devices, determining or informing decisions as well as other applications. In addition to providing a model for forecasting time-series data that can scale efficiently with large datasets, the model provides improved forecasting results by decoupling the time-series data into the time-variant portion and the time-invariant portion.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment.

Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. A method for time series forecasting comprising:
receiving a time-series of observational data (yₜ) for a time (t) from t=1 to T;
receiving a time-series of auxiliary data (xₜ) from t=1 to T+H, where:
yₜ|y_{<t},x_{≤t}; and
H is a number of forecasting steps;
aggregating time-invariant local context of the received time-series by applying the received time series to a neural network (g);
determining dynamic control variable (ϕₜ)based on time-variant global dynamics of the received time series using a random walk process;
predicting parameters of a conditional distribution by modulating the aggregated time-invariant local context by the dynamic control variable; and
using the predicted parameters of the of the conditional distribution to forecast observational data yₜ for t=1 to T+H; and
outputting yₜ for t=1 to T+H.

2. The method of claim 1, wherein the neural network g maps yₜ and xₜ to a vector hₜ as:
hₜ=g(y_{1:T},x_{T+1}).

3. The method of claim 2, wherein aggregating the time-invariant context further comprises transforming hₜ into P vectors, each of dimension E.

4. The method of claim 3, wherein hₜ is transformed into the P vectors according to:
z_{t,i}=tan h(W_{z,i}hₜ+b_{z,i}),∀i=1, . . . ,P.

5. The method of claim 1, wherein the dynamic control variable φₜ is determined based on a dynamic stochastic process (χₜ).

6. The method of claim 5, wherein ϕₜ is determined according to:
ϕₜ=χₜ+b_{ϕ},
where b_{ϕ} is a static vector.

7. The method of claim 6, wherein χₜ is determined from a generative process according to:
πₜ˜ [symbol] (λ);
χₜ˜ [symbol] (0,Σ₀), if πₜ=0;
χₜ=χₜ₋₁+∈ₜ if πₜ=1;
∈ₜ˜ [symbol] (0,Σ_{d}),
where: [symbol]
denotes a Bernoulli distribution; and [symbol]
denotes a normal distribution.

8. The method of claim 1, wherein using the predicted parameters of the of the conditional distribution to forecast observational data yₜ comprises:
sampling trajectories of p(χ_{T+1:T+H}|y_{1:T}, x_{1:T}); and
sampling trajectories of p(y_{T+1:T+H}|y_{T+1-B:T}, x_{T+1-B:T+H}, χ_{T+1:T+H}) using the sampled trajectories of p(χ_{T+1:T+H}|y_{1:T}, x_{1:T}).

9. The method of claim 8, wherein the trajectories of p(χ_{T+1:T+H}|y_{1:T}, x_{1:T}) are sampled from a dynamic model comprising a posterior model and prior model.

10. The method of claim 9, wherein the trajectories of p(y_{T+1:T+H}|y_{T+1-B:T}, x_{T+1-B:T+H}, χ_{T+1:T+H}) are sampled from a stationary conditional distribution model.

11. The method of claim 10, further comprising training each of the stationary conditional distribution model, the prior model and the posterior model based on historical data {(yₜ,xₜ)}ₜ₌₁^{T}.

12. The method of claim 11, wherein training the posterior model is done using blocks of time in parallel.

13. The method of claim 12, wherein for training the posterior model, for the i-th time block out t∈(bᵢ, bᵢ₊₁], out of K blocks, δₜ is sampled in parallel across t according to:
δₜ˜ [symbol] ((1−aₜ)⊙mₜ,diag(sₜ²)); and
χₜ computed according to:
χₜ=Π_{v∈(b}_{ᵢ}_{,t]}aᵥ⊙χ_{b}_{ᵢ}+Σ_{u∈(b}_{ᵢ}_{,t]}Π_{v∈(u,t]}aᵥ⊙δᵤ.

14. A non-transitory computer readable medium having stored thereon computer program code that is executable by a processor and that, when executed by the processor, causes the processor to perform the method of claim 1.

15. A computer system comprising:
a processor for executing instructions; and
a memory storing instructions, which when executed by the processor configure the computer system to perform the method of claim 1.
